(19) United States
(12) Patent Application Publication
(10) Pub. No.: US 2020/0273134 A1
(43) Pub. Date: Aug. 27, 2020

(54) OPERATION ASSISTANCE APPARATUS AND VEHICLE

(71) Applicant: TOYOTA JIDOSHA KABUSHIKI KAISHA, Toyota-shi (JP)

(72) Inventors: Taiki YOSHIDA, Tokyo (JP); Saiko TOYODA, Nagoya-shi (JP)

(73) Assignee: TOYOTA JIDOSHA KABUSHIKI KAISHA, Toyota-shi (JP)

(21) Appl. No.: 16/720,323

(22) Filed: Dec. 19, 2019

(30) Foreign Application Priority Data
Feb. 26, 2019 (JP) 2019-033367

(51) Int. Cl. G06Q 50/30; G08G 1/123; G06Q 10/02

(52) U.S. Cl. CPC G06Q 50/30; G06Q 10/02; G08G 1/123

(57) ABSTRACT

An operation assistance apparatus is an apparatus that assists in the operation of a vehicle for which an operation schedule is determined in accordance with a boarding position requested in a reservation. The operation assistance apparatus includes a control unit that determines whether a user is present or not at the boarding position at a time when the vehicle has arrived at the boarding position, and when determining that the user is not present, sets a stop time of the vehicle at the boarding position in accordance with the delay status of the vehicle with respect to the operation schedule at the time and with the operation schedule subsequent to the time.

### INCORPORATION BY REFERENCE

The disclosure of Japanese Patent Application No. 2019-033367 filed on Feb. 26, 2019 including the specification, drawings and abstract is incorporated herein by reference in its entirety.

### BACKGROUND

### 1. Technical Field

The present disclosure relates to an operation assistance apparatus and a vehicle.

### 2. Description of Related Art

Japanese Patent Application Publication No. 2018-060372 describes a technique that estimates a time at which a user will arrive at a pickup location based on information acquired from a user terminal and a transportation server and corrects or regenerates a generated car dispatching plan, if necessary.

### SUMMARY

In some on-demand transportation systems such as on-demand buses, an operation schedule such as a travel route and a servicing schedule is determined in accordance with positions of and times of boarding and alighting requested by users in their reservations. In such a transportation system, it is necessary to wait for a user in case the user is not present at the position where the user is scheduled to board. If there are other users to board, however, it would not be possible to wait for a single user to arrive.

With the technique described in JP 2018-060372 A, a pickup driver cannot know how long he/she should wait for a user if the user is not present at a time when a pickup vehicle has arrived at the pickup location.

The present disclosure has a purpose of determining a time to wait for a user in case the user is not present at a position where the user is scheduled to board.

An operation assistance apparatus according to an embodiment of the present disclosure is an operation assistance apparatus that assists in operation of a vehicle for which an operation schedule is determined in accordance with a boarding position requested in a reservation, the operation assistance apparatus including a control unit that determines whether a user is present or not at the boarding position at a time when the vehicle has arrived at the boarding position, and when determining that the user is not present, sets a stop time of the vehicle at the boarding position in accordance with a delay status of the vehicle with respect to the operation schedule at the time and with the operation schedule subsequent to the time.

An embodiment of the present disclosure allows determination of a time to wait for a user in case the user is not present at a position where the user is scheduled to board.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a block diagram showing a configuration of a vehicle according to an embodiment of the present disclosure;

FIG. 2 is a flowchart showing actions of an operation assistance apparatus according to an embodiment of the present disclosure;

FIG. 3 shows an example of approval request information according to an embodiment of the present disclosure; and

FIG. 4 shows an example of approval request information according to an embodiment of the present disclosure.

### DETAILED DESCRIPTION OF EMBODIMENTS

An embodiment of the present disclosure is described below with reference to drawings.

In the drawings, the same or equivalent elements are given the same reference numerals. In description of this embodiment, the same or equivalent elements are not described again or briefly described where appropriate.

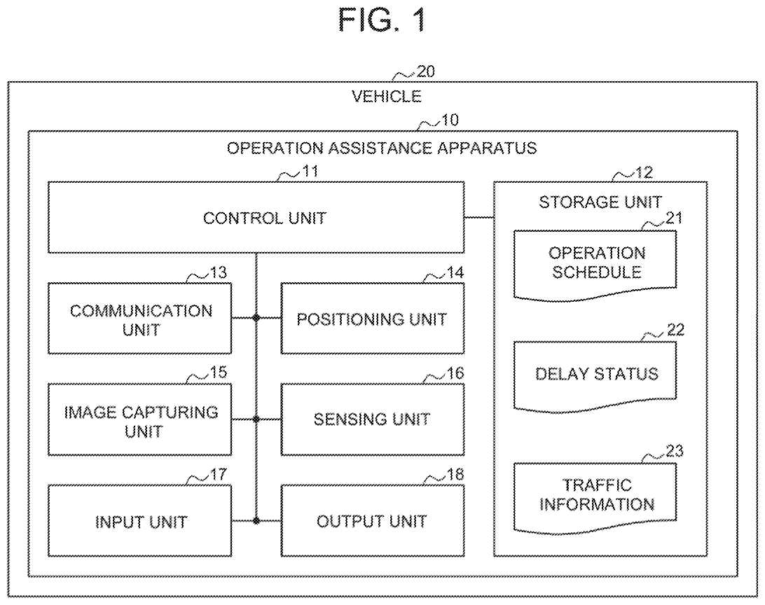

Referring to FIG. 1, this embodiment is outlined.

An operation schedule 21 for a vehicle 20 is determined in accordance with a boarding position P1 which is requested in a reservation. An operation assistance apparatus 10 determines whether a user is present or not at the boarding position P1 at a time T1 when the vehicle 20 has arrived at the boarding position P1. When it determines that the user is not present, the operation assistance apparatus 10 sets a stop time Ts of the vehicle 20 at the boarding position P1 in accordance with a delay status 22 of the vehicle 20 with respect to the operation schedule 21 at the time T1 and with the operation schedule 21 subsequent to the time T1. In this embodiment, the operation assistance apparatus 10 sets the stop time Ts also in accordance with traffic information 23 for a road when determining that the user is not present.

This embodiment allows determination of a time to wait for a user in case the user is not present at a position where the user is scheduled to board.

The vehicle 20 in this embodiment is an on-demand bus; however, it may be other kind of on-demand vehicle, such as a shared taxi. The on-demand bus can be any type of automobile, such as a gasoline vehicle, a diesel vehicle, an HV, a PHV, an EV, or an FCV, for example. “HV” is an abbreviation of Hybrid Vehicle. “PHV” is an abbreviation of Plug-in Hybrid Vehicle. “EV” is an abbreviation of Electric Vehicle. “FCV” is an abbreviation of Fuel Cell Vehicle. The vehicle 20 is driven by a driver in this embodiment; however, its driving may be automated at a certain level. The level of automation is one of Levels 1 to 5 of SAE levels of automation, for example. “SAE” is an abbreviation of Society of Automotive Engineers. The vehicle 20 may also be a MaaS-specific vehicle. “MaaS” is an abbreviation of Mobility as a Service.

The vehicle 20 in this embodiment allows shared riding and can accommodate a large unspecified number of users; however, it may also accommodate a single user or a small number of specific users.

Referring to FIG. 1, a configuration of the vehicle 20 according to this embodiment is described.

The vehicle 20 includes the operation assistance apparatus 10.

The operation assistance apparatus 10 is an apparatus that assists in the operation of the vehicle 20. The operation assistance apparatus 10 may be configured as a vehicle-mounted device such as a fare indicator, a fare collection device, or a navigation device, or as an electronic device for use via connection to a vehicle-mounted device, such as a mobile phone, a smartphone, or a tablet.

The operation assistance apparatus 10 includes components such as a control unit 11, a storage unit 12, a communication unit 13, a positioning unit 14, an image capturing unit 15, a sensing unit 16, an input unit 17, and an output unit 18.

The control unit 11 is one or more processors. The processor can be a general-purpose processor such as a CPU, or a dedicated processor designed specifically for a particular kind of processing. “CPU” is an abbreviation of Central Processing Unit. The control unit 11 may include one or more dedicated circuits, or one or more processors of the control unit 11 may be replaced with one or more dedicated circuits. The dedicated circuit can be a FPGA or an ASIC, for example. “FPGA” is an abbreviation of Field-Programmable Gate Array. “ASIC” is an abbreviation of Application Specific Integrated Circuit. The control unit 11 may include one or more ECUs. “ECU” is an abbreviation of Electronic Control Unit. The control unit 11 performs information processing related to actions of the operation assistance apparatus 10 while controlling components of the vehicle 20, including the operation assistance apparatus 10.

The storage unit 12 is one or more memories. The memory can be semiconductor memory, magnetic memory, or optical memory, for example. The semiconductor memory can be RAM or ROM, for example. “RAM” is an abbreviation of Random Access Memory. “ROM” is an abbreviation of Read Only Memory. The RAM can be SRAM or DRAM, for example. “SRAM” is an abbreviation of Static Random Access Memory. “DRAM” is an abbreviation of Dynamic Random Access Memory. The ROM can be EEPROM, for example. “EEPROM” is an abbreviation of Electrically Erasable Programmable Read Only Memory. The memory functions as main storage, auxiliary storage, or cache memory, for example. The storage unit 12 stores information for use in the actions of the operation assistance apparatus 10 and information obtained through the actions of the operation assistance apparatus 10.

The communication unit 13 is one or more communication modules. The communication module can be a communication module that supports LTE, 4G, or 5G, for example. “LTE” is an abbreviation of Long Term Evolution. “4G” is an abbreviation of 4th Generation. “5G” is an abbreviation of 5th Generation. The communication unit 13 receives information for use in the actions of the operation assistance apparatus 10 and sends information obtained through the actions of the operation assistance apparatus 10.

The positioning unit 14 is one or more positioning modules. The positioning module can be a positioning module that supports GNSS, for example. “GNSS” is an abbreviation of Global Navigation Satellite System. The GNSS includes at least one of GPS, QZSS, GLONASS, and Galileo, for example. “GPS” is an abbreviation of Global Positioning System. “QZSS” is an abbreviation of Quasi-Zenith Satellite System. A satellite for the QZSS is referred to as a quasi-zenith satellite. “GLONASS” is an abbreviation of Global Navigation Satellite System. The positioning unit 14 acquires position information of the vehicle 20.

The image capturing unit 15 is one or more vehicle-mounted cameras. The vehicle-mounted camera can be a front camera, a side camera, a rear camera, or an in-car camera, for example. The image capturing unit 15 may include one or more vehicle-mounted radars or one or more vehicle-mounted LiDARs, or one or more vehicle-mounted cameras of the image capturing unit 15 may be replaced with one or more vehicle-mounted radars or one or more vehicle-mounted LiDARs. “LiDAR” is an abbreviation of Light Detection and Ranging. The image capturing unit 15 captures images from the vehicle 20. That is, the image capturing unit 15 captures images of an outside of the vehicle 20. The image capturing unit 15 may further capture images of an inside of the vehicle 20.

The sensing unit 16 is one or more sensors. The sensor can be a car speed sensor, an acceleration sensor, a gyroscope, a human presence sensor, or a door open/close sensor, for example. The sensing unit 16 observes various events in different portions of the vehicle 20 and obtains results of observation as information for use in the actions of the operation assistance apparatus 10.

The input unit 17 is one or more input interfaces. The input interface can be physical keys, capacitive keys, a pointing device, a touch screen integral with a vehicle-mounted display, or a vehicle-mounted microphone, for example. The input unit 17 accepts manipulations by a driver of the vehicle 20 such as for inputting information for use in the actions of the operation assistance apparatus 10.

The output unit 18 is one or more output interfaces. The output interface can be a vehicle-mounted display or a vehicle-mounted speaker, for example. The vehicle-mounted display can be an HUD, an LCD, or an organic EL display, for example. “HUD” is an abbreviation of Head-Up Display. “LCD” is an abbreviation of Liquid Crystal Display. “EL” is an abbreviation of Electro Luminescence. The output unit 18 outputs information obtained through the actions of the operation assistance apparatus 10 to the driver of the vehicle 20.

Functions of the operation assistance apparatus 10 are implemented by execution of an operation assistance program according to this embodiment by a processor included in the control unit 11. That is, the functions of the operation assistance apparatus 10 are implemented by software. The operation assistance program is a program for making a computer execute processing of steps included in the actions of the operation assistance apparatus 10, thereby making the computer implement the functions corresponding to the processing of the steps. That is, the operation assistance program is a program for causing the computer to function as the operation assistance apparatus 10.

The program can be recorded on a computer-readable recording medium. The computer-readable recording medium can be a magnetic recording device, an optical disk, a magneto-optical recording medium, or semiconductor memory, for example. The program is distributed through, for example, sale, transfer, or loaning of a removable recording medium such as a DVD or CD-ROM with the program recorded thereon. “DVD” is an abbreviation of Digital Versatile Disc. “CD-ROM” is an abbreviation of Compact Disc Read Only Memory. The program may also be distributed by storing the program in a storage of a server and transferring the program to other computers from the server over a network. The program may be provided as a program product.

A computer temporarily stores the program recorded on the removable recording medium or the program transferred from the server into a memory, for example. The computer then reads the program stored in the memory through a processor and executes processing conforming to the program with the processor. The computer may read the program directly from the removable recording medium and execute processing conforming to the program. The computer may execute processing conforming to a received program one by one each time a program is transferred to the computer from the server. Processing may also be executed via a so-called ASP service, which implements functions solely by commanding of execution and acquiring of results without transferring programs from a server to a computer. “ASP” is an abbreviation of Application Service Provider. A program encompasses information that is intended for use in processing by an electronic computer and is comparable to a program. For example, data that is not a direct command to a computer but has a nature defining processing to be done by the computer corresponds to being “comparable to a program”.

Some or all of the functions of the operation assistance apparatus 10 may be implemented by the dedicated circuit(s) included in the control unit 11. That is, some or all of the functions of the operation assistance apparatus 10 may be implemented by hardware.

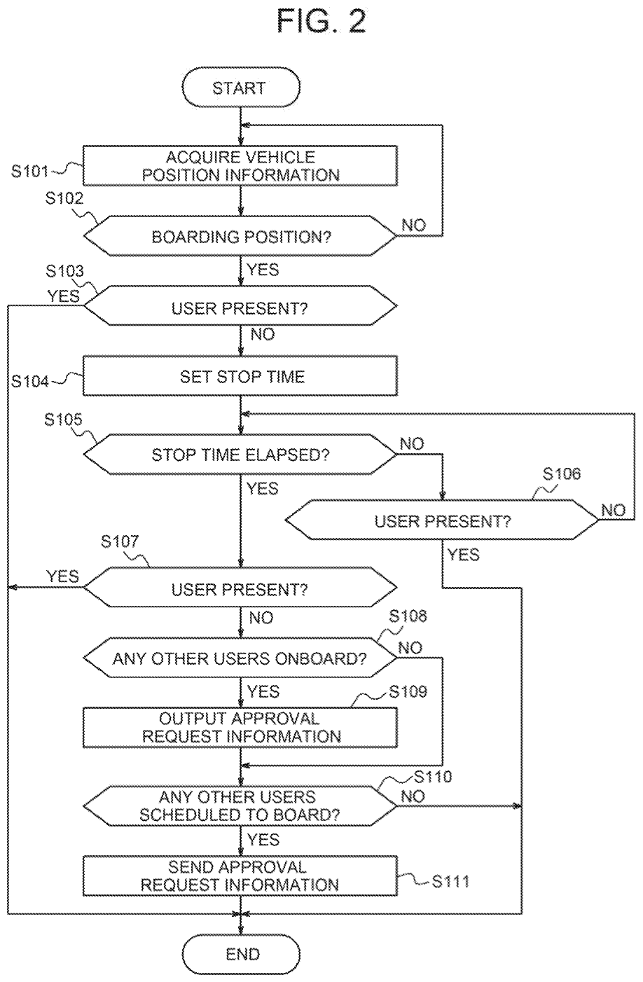

Referring to FIG. 2, the actions of the operation assistance apparatus 10 according to this embodiment are described. The actions of the operation assistance apparatus 10 correspond to an operation assistance method according to this embodiment.

At step S101, the control unit 11 acquires the position information of the vehicle 20 via the positioning unit 14.

Specifically, using the positioning module included in the positioning unit 14, the control unit 11 acquires two-dimensional or three-dimensional coordinates of a current position of the vehicle 20 as the position information of the vehicle 20. The control unit 11 stores the acquired two-dimensional or three-dimensional coordinates in the storage unit 12.

At step S102, the control unit 11 determines whether the position of the vehicle 20 indicated by the position information acquired at step S101 is the boarding position P1 that was requested by the user at a time of reservation.

Specifically, the control unit 11 calculates the distance between the two-dimensional or three-dimensional coordinates of the current position stored in the storage unit 12 and coordinates or a coordinate range of the boarding position P1 prestored in the storage unit 12. If the calculated distance is smaller than a threshold, the control unit 11 determines that the current position of the vehicle 20 is the boarding position P1. If the calculated distance is larger than the threshold, the control unit 11 determines that the current position of the vehicle 20 is not the boarding position P1. Instead of prestoring information such as the coordinates or coordinate range of the boarding position P1 in the storage unit 12, the control unit 11 may acquire it from a server external to the vehicle 20 over a mobile communication network and a network like the Internet.

If it determines that the position of the vehicle 20 is the boarding position P1 at step S102, the control unit 11 performs processing of step S103. That is, the control unit 11 performs the processing of step S103 at the time T1 when the vehicle 20 has arrived at the boarding position P1. By contrast, if it determines that the position of the vehicle 20 is not the boarding position P1 at step S102, the control unit 11 performs processing of step S101 again. That is, the control unit 11 repeats the processing of step S101 until the vehicle 20 has arrived at the boarding position P1.

At step S103, the control unit 11 determines whether the user is present or not at the boarding position P1.

Specifically, the control unit 11 captures an image of the outside of the vehicle 20, in particular a road side such as a sidewalk, using the vehicle-mounted camera included in the image capturing unit 15. The control unit 11 analyzes the captured image and detects any person captured therein. For a technique to detect a person in an image, an image recognition technique based on machine learning, pattern matching, feature point extraction, or any combination of them can be used, for example. If the control unit 11 detects a person captured in the image, the control unit 11 assumes that the person is the user and determines that the user is present at the boarding position P1. By contrast, if it detects no person captured in the image, the control unit 11 determines that the user is not present at the boarding position P1.

As a variation of this embodiment, if it detects a person captured in an image, the control unit 11 may determine whether the person is the user with reference to information showing characteristics of the user prestored in the storage unit 12. In that case, the control unit 11 would determine that the user is present at the boarding position P1 if the characteristics of the person in the image match the characteristics of the user. By contrast, even when it has detected a person in the image, the control unit 11 would determine that the user is not present at the boarding position P1 if the characteristics of the person in the image do not match the characteristics of the user.

As a variation of this embodiment, the control unit 11 may accept a manipulation by the driver of the vehicle 20 for inputting information that shows whether the user is present or not at the boarding position P1 via the input unit 17. In that case, the control unit 11 determines that the user is present at the boarding position P1 if the input information shows that the user is present. By contrast, if the input information shows that the user is not present, the control unit 11 determines that the user is not present at the boarding position P1.

If it determines that the user is present at step S103, the control unit 11 ends processing. If the vehicle 20 is to head for a next boarding position P2 after the user boarded the vehicle 20, the control unit 11 performs processing of step S101 and subsequent steps for the boarding position P2. By contrast, if it determines that the user is not present at step S103, the control unit 11 performs processing of step S104.

At step S104, the control unit 11 sets the stop time Ts of the vehicle 20 at the boarding position P1 in accordance with the delay status 22 of the vehicle 20 with respect to the operation schedule 21 at the time T1 and with the operation schedule 21 subsequent to the time T1. In this embodiment, the control unit 11 sets the stop time Ts also in accordance with traffic information 23 for a road.

Specifically, the control unit 11 calculates a delay time Td, which is the difference between the time of day of the time T1 and a scheduled time of arrival at the boarding position P1 included in the operation schedule 21 prestored in the storage unit 12. The control unit 11 stores the calculated delay time Td in the storage unit 12 as the delay status 22 of the vehicle 20 with respect to the operation schedule 21 at the time T1. The control unit 11 sets the stop time Ts of the vehicle 20 at the boarding position P1 in accordance with the delay time Td stored in the storage unit 12, the number of other users N1 who are scheduled to board at the next boarding position P2 after the boarding position P1 onward, which is included in the operation schedule 21 subsequent to the time T1 prestored in the storage unit 12, and a level of congestion J1 of a road from the boarding position P1 to the boarding position P2, which is included in the traffic information 23 prestored in the storage unit 12.

As a specific example, the control unit 11 sets the stop time Ts shorter as the delay time Td is longer. The control unit 11 sets the stop time Ts shorter as the number of other users N1 is larger. The control unit 11 sets the stop time Ts shorter as the level of congestion J1 is higher. Conversely, the control unit 11 sets the stop time Ts longer as the delay time Td is shorter. The control unit 11 sets the stop time Ts longer as the number of other users N1 is smaller. The control unit 11 sets the stop time Ts longer as the level of congestion J1 is lower. In this example, the time to wait for a user can be dynamically determined in accordance with the delay time Td, the number of other users N1, or the level of congestion J1.

Instead of prestoring the operation schedule 21 and the traffic information 23 in the storage unit 12, the control unit 11 may acquire them from a server external to the vehicle 20 over a mobile communication network and a network like the Internet. The number of other users N1 may not be explicitly indicated in the operation schedule 21 subsequent to the time T1 and the control unit 11 may calculate the number of other users N1 from other information included in the operation schedule 21 subsequent to the time T1. The level of congestion J1 may not be explicitly indicated in the traffic information 23 and the control unit 11 may calculate the level of congestion J1 from other information included in the traffic information 23.

As a variation of this embodiment, the control unit 11 may predict, as the stop time Ts, a range R1 that does not create a delay of the vehicle 20 with respect to the operation schedule 21 subsequent to the time T1 at the next boarding position P2 after the boarding position P1. The control unit 11 may set the stop time Ts as an upper limit of the predicted range R1. In that case, the control unit 11 calculates an available time Ta, which is the difference between the time of day of the time T1 and a scheduled time of arrival at the boarding position P2 included in the operation schedule 21 subsequent to the time T1. The control unit 11 stores the calculated available time Ta in the storage unit 12 as the delay status 22 of the vehicle 20 with respect to the operation schedule 21 at the time T1. The control unit 11 sets the stop time Ts of the vehicle 20 at the boarding position P1 in accordance with the available time Ta stored in the storage unit 12, a travel route W1 from the boarding position P1 to the boarding position P2 included in the operation schedule 21 subsequent to the time T1, and the level of congestion J1 of the road from the boarding position P1 to the boarding position P2 included in the traffic information 23 prestored in the storage unit 12.

As a specific example, the control unit 11 calculates, as the upper limit of the range R1, the difference between the available time Ta and a required time Tr, which is the product of a time determined by dividing the travel route W1 by an average velocity of the vehicle 20 or a reference velocity and a weighting factor corresponding to the level of congestion J1. A lower limit of the range R1 is 0. The control unit 11 sets the stop time Ts as the upper limit of the range R1. In this example, it is possible to wait for a user up to a latest possible time that allows the next boarding position P2 to be reached without delay.

The control unit 11 indicates the stop time Ts that was set at step S104 to the driver of the vehicle 20 via the output unit 18 or, if driving of the vehicle 20 is automated, controls the vehicle 20 to keep the vehicle 20 stopped.

At step S105, the control unit 11 determines whether the stop time Ts that was set at step S104 has elapsed. If it determines that the stop time Ts has not elapsed, the control unit 11 performs processing of step S106. By contrast, if it determines that the stop time Ts has elapsed, the control unit 11 performs processing of step S107. That is, the control unit 11 performs the processing of step S107 upon elapse of the stop time Ts.

At step S106, the control unit 11 determines whether the user is present or not at the boarding position P1 as in the processing of step S103.

If it determines that the user is present at step S106, the control unit 11 ends processing. If the vehicle 20 is to head for the next boarding position P2 after the user boarded the vehicle, the control unit 11 performs processing of step S101 and subsequent steps for the boarding position P2. By contrast, if it determines that the user is not present at step S106, the control unit 11 performs the processing of step S105 again.

At step S107, the control unit 11 determines whether the user is present or not at the boarding position P1 as in the processing of step S103.

If it determines that the user is present at step S107, the control unit 11 ends processing. If the vehicle 20 is to head for the next boarding position P2 after the user boarded the vehicle, the control unit 11 performs processing of step S101 and subsequent steps for the boarding position P2. By contrast, if it determines that the user is not present at step S107, the control unit 11 performs processing of step S108.

At step S108, the control unit 11 determines whether there are other users on board.

Specifically, the control unit 11 captures an image of the inside of the vehicle 20 using the in-car camera included in the image capturing unit 15. The control unit 11 analyzes the captured image and detects any person captured therein. For a technique to detect a person in an image, an image recognition technique based on machine learning, pattern matching, feature point extraction, or any combination of them can be used, for example. If it detects any person captured in the image, the control unit 11 determines that there are other users on board. By contrast, if it detects no person captured in the image, the control unit 11 determines that there are no other users on board.

As a variation of this embodiment, the control unit 11 may accept via the input unit 17 a manipulation by the driver of the vehicle 20 for inputting information showing whether there are other users on board. In that case, the control unit 11 determines that other users are on board if the input information shows that there are other users on board. By contrast, if the input information shows that there are no other users on board, the control unit 11 determines that there are no other users on board.

If it determines that there are other users on board at step S108, the control unit 11 performs processing of step S109. By contrast, if it determines that there are no other users on board at step S108, the control unit 11 performs processing of step S110.

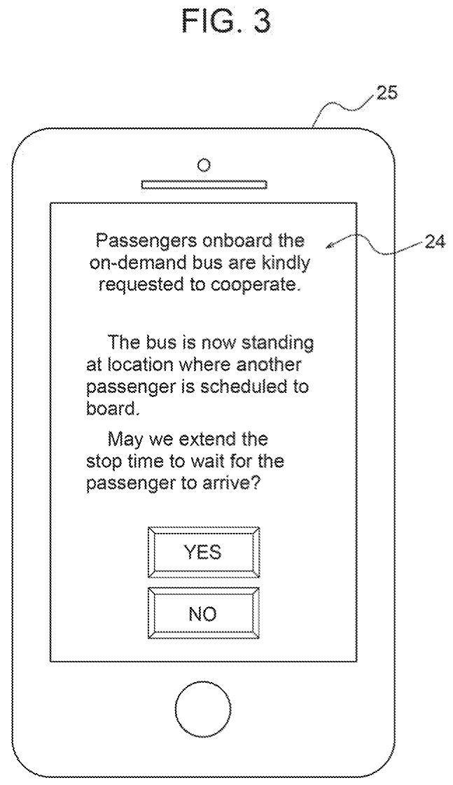

At step S109, the control unit 11 performs control to output approval request information 24 for requesting approval of the other users who are on board the vehicle 20 to extension of the stop time Ts, as shown in the example of FIG. 3.

In the example of FIG. 3, the control unit 11 sends, via the communication unit 13, the approval request information 24 to a terminal device 25 of the other users on board, such as a mobile phone, a smartphone, or a tablet, thereby controlling the terminal device 25 to output the approval request information 24. The terminal device 25 receives the approval request information 24 and displays the received approval request information 24 on a display. The approval request information 24 may be sent by e-mail or by communication via a dedicated application. Destination information for the terminal device 25 may be registered as part of the operation schedule 21 at the time of reservation or may be acquired at the time of boarding. If other user on board makes an approving operation, such as pressing a “YES” button, on the approval request information 24 being displayed, the control unit 11 receives information indicating that the extension of the stop time Ts has been approved from the terminal device 25 via the communication unit 13. The control unit 11 instructs the driver of the vehicle 20 to extend the stop time Ts via the output unit 18, or if the driving of the vehicle 20 is automated, controls the vehicle 20 to keep the vehicle 20 stopped.

As another example, the control unit 11 may also control the output unit 18 so as to output the approval request information 24.

At step S110, the control unit 11 determines whether there are other users who are scheduled to board at the next boarding position P2 after the boarding position P1 onward.

Specifically, when there are reservations from other users who desire to board at the next boarding position P2 after the boarding position P1 onward with reference to the operation schedule 21 subsequent to the time T1 prestored in the storage unit 12, the control unit 11 determines that other users are scheduled to board at the boarding position P2 onward. If there are no such reservations, the control unit 11 determines that no other users are scheduled to board at the boarding position P2 onward.

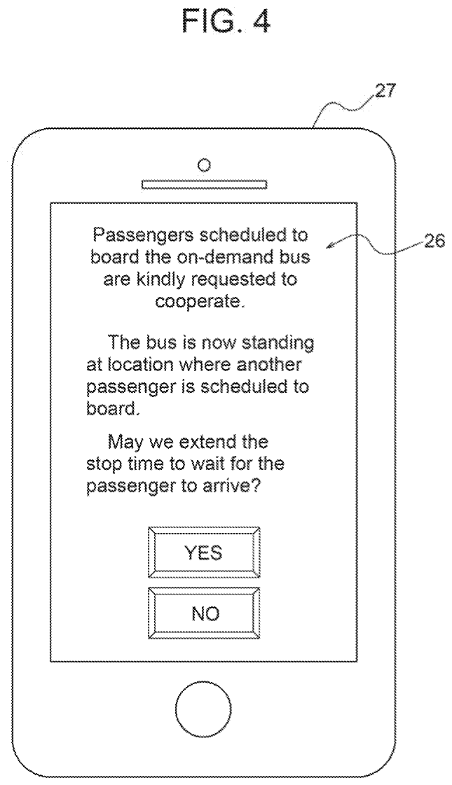

At step S111, the control unit 11 sends, via the communication unit 13, approval request information 26 for requesting approvals of the other users who are scheduled to board at the next boarding position P2 after the boarding position P1 onward to the extension of the stop time Ts, as shown in the example of FIG. 4.

In the example of FIG. 4, the control unit 11 sends, via the communication unit 13, the approval request information 26 to a terminal device 27 of other user scheduled to board at the boarding position P2 onward, such as a mobile phone, a smartphone, or a tablet, thereby controlling the terminal device 27 to output the approval request information 26. The terminal device 27 receives the approval request information 26 and displays the received approval request information 26 on a display. The approval request information 26 may be sent by e-mail or by communication via a dedicated application. Destination information for the terminal device 27 is registered as part of the operation schedule 21 at the time of reservation. If the other users scheduled to board at the boarding position P2 onward make an approving operation, such as pressing a “YES” button, on the approval request information 26 being displayed, the control unit 11 receives information indicating that the extension of the stop time Ts has been approved from the terminal device 27 via the communication unit 13. The control unit 11 instructs the driver of the vehicle 20 to extend the stop time Ts via the output unit 18, or if the driving of the vehicle 20 is automated, controls the vehicle 20 to keep the vehicle 20 stopped.

As described above, the operation assistance apparatus 10 in this embodiment assists in the operation of the vehicle 20 for which the operation schedule 21 is determined in accordance with the boarding position P1 requested in a reservation. The control unit 11 of the operation assistance apparatus 10 determines whether a user is present or not at the boarding position P1 at the time T1 when the vehicle 20 has arrived at the boarding position P1. When determining that the user is not present, the control unit 11 sets the stop time Ts of the vehicle 20 at the boarding position P1 in accordance with the delay status 22 of the vehicle 20 with respect to the operation schedule 21 at the time T1 and with the operation schedule 21 subsequent to the time T1. Thus, this embodiment allows determination of the time to wait for a user in case the user is not present at a position where the user is scheduled to board.

As a variation of this embodiment, the operation assistance apparatus 10 may be configured as a server belonging to a cloud computing system or other kind of computing system. In that case, the processing of step S108 is executed at the vehicle 20. The processing of steps S101 through S107 and steps S109 through S111 are executed at the server. At step S101, the position information of the vehicle 20 is uploaded from the vehicle 20 to the server to be acquired by the server. At step S104, the stop time Ts that has been set is indicated to the vehicle 20 by the server. At steps S103, S106 and S107, information required for processing, such as a road side image, is uploaded from the vehicle 20 to the server.

An applicable embodiment of the present disclosure is not limited to the foregoing embodiment. For example, multiple blocks described in a block diagram may be combined together or a single block may be divided. Instead of executing multiple steps described in a flowchart in a chronological sequence in concert with description, the steps may be executed in parallel or in a different sequence depending on processing ability of a device that executes the steps or any necessity. Other modifications are also possible without departing from the scope of the present disclosure.

What is claimed is:

1. An operation assistance apparatus that assists in operation of a vehicle for which an operation schedule is determined in accordance with a boarding position requested in a reservation, the operation assistance apparatus comprising a control unit that determines whether a user is present or not at the boarding position at a time when the vehicle has arrived at the boarding position, and when determining that the user is not present, sets a stop time of the vehicle at the boarding position in accordance with a delay status of the vehicle with respect to the operation schedule at the time and with the operation schedule subsequent to the time.

2. The operation assistance apparatus according to claim 1, wherein when determining that the user is not present, the control unit sets the stop time also in accordance with traffic information for a road.

3. The operation assistance apparatus according to claim 1, wherein the vehicle allows shared riding, and when determining that the user is not present, the control unit sets the stop time in accordance with the number of other users who are scheduled to board at a next boarding position after the boarding position onward included in the operation schedule subsequent to the time.

4. The operation assistance apparatus according to claim 1, wherein the vehicle allows shared riding, and when determining that the user is not present, the control unit predicts as the stop time a range that does not create a delay of the vehicle with respect to the operation schedule at a next boarding position after the boarding position, and sets the stop time as an upper limit of the predicted range.

5. The operation assistance apparatus according to claim 1, wherein the control unit determines whether the user is present or not at the boarding position again upon elapse of the stop time, and when determining that the user is not present, performs control to output approval request information for requesting approval of another user who is on board the vehicle to extension of the stop time.

6. The operation assistance apparatus according to claim 1, further comprising a communication unit that sends information,
wherein the control unit determines whether the user is present or not at the boarding position again upon elapse of the stop time, and when determining that the user is not present, sends via the communication unit approval request information for requesting approval of another user who is scheduled to board at a next boarding position after the boarding position onward to extension of the stop time.

7. A vehicle comprising the operation assistance apparatus according to claim 1.
